(19) United States
(12) Patent Application Publication
(10) Pub. No.: US 2015/0285152 A1
(43) Pub. Date: Oct. 8, 2015

(54) GAS TURBINE ENGINE AND SEAL ASSEMBLY THEREFORE

(71) Applicant: United Technologies Corporation, Hartford, CT (US)

(72) Inventors: Richard K. Hayford, Cape Neddick, ME (US); Bryan N. Budd, Saco, ME (US)

(21) Appl. No.: 14/671,098

(22) Filed: Mar. 27, 2015

Related U.S. Application Data
(60) Provisional application No. 61/974,712, filed on Apr. 3, 2014.

(51) Int. Cl. F02C 7/28; F01D 11/02

(52) U.S. Cl. CPC F02C 7/28; F01D 11/02

(57) ABSTRACT

The present disclosure relates generally to a hydrostatic advanced low leakage seal having a plurality of shoes, each supported by at least one spring element. The mass and/or circumferential length of some of the shoes and/or the spring rate of some of the beams may be changed in order to provide different vibratory responses for different shoe/beam assemblies.

### CROSS REFERENCE TO RELATED APPLICATION

This application claims the benefit of and incorporates by reference herein the disclosure of U.S. Ser. No. 61/974,712, filed Apr. 3, 2014.

### GOVERNMENT LICENSE RIGHTS

This invention was made with government support under Contract No. FA8650-09-D-2923-0021 awarded by the United States Air Force. The government has certain rights in the invention.

### TECHNICAL FIELD OF THE DISCLOSURE

The present disclosure is generally related to hydrostatic advanced low leakage seals and, more specifically, to a system and method for dampening vibration in a hydrostatic advanced low leakage seal.

### BACKGROUND OF THE DISCLOSURE

So-called hydrostatic advanced low leakage seals, or hybrid seals, such as those described in U.S. Pat. No. 8,002,285 to name one non-limiting example, exhibit less leakage compared to traditional knife edge seals while exhibiting a longer life than brush seals. In one non-limiting example, the hybrid seal may be used to seal between a stator and a rotor within a gas turbine engine. The hybrid seal is mounted to one of the stator or the rotor to maintain a desired gap dimension between the hybrid seal and the other of the stator and rotor. The hybrid seal has the ability to ‘track’ the relative movement between the stator and the rotor throughout the engine operating profile when a pressure is applied across the seal. The hybrid seal tracking surface is attached to a solid carrier ring via continuous thin beams. These beams enable the low resistance movement of the hybrid seal in a radial direction. The dimensions of the beams exhibit vibrational characteristics that could be excited in the engine operating environment. Improvements in such hybrid seals are therefore desirable.

### SUMMARY OF THE DISCLOSURE

In one embodiment, seal assembly disposed between a stator and a rotor is disclosed, the seal assembly comprising: a hydrostatic advanced low leakage seal including: a base; a plurality of shoes of substantially equal circumferential length, wherein a first mass of a first portion of the plurality of shoes is different than a second mass of a second portion of the plurality of shoes; and a plurality of spring elements, each of the plurality of spring elements operatively coupling one of the plurality of shoes to the base; wherein the base is operatively coupled to one of the stator and the rotor.

In a further embodiment of the above, the base is operatively coupled to the stator.

In a further embodiment of any of the above, the plurality of shoes comprise shoes of the first mass alternating with shoes of the second mass around a circumference of the hydrostatic low leakage seal.

In a further embodiment of any of the above, each of the plurality of spring elements comprise substantially the same spring rate.

In a further embodiment of any of the above, a third mass of a third portion of the plurality of shoes is different than the first mass and the second mass.

In another embodiment, a seal assembly disposed between a stator and a rotor is disclosed, the seal assembly comprising: a hydrostatic advanced low leakage seal including: a base; a plurality of shoes, wherein a first circumferential length of a first portion of the plurality of shoes is different than a second circumferential length of a second portion of the plurality of shoes; and a plurality of spring elements, each of the plurality of spring elements operatively coupling one of the plurality of shoes to the base; wherein a first spring rate of a first portion of the plurality of spring elements is different than a second spring rate of a second portion of the plurality of spring elements; wherein the base is operatively coupled to one of the stator and the rotor.

In a further embodiment of the above, the base is operatively coupled to the stator.

In a further embodiment of any of the above, the plurality of shoes comprise shoes of the first circumferential length alternating with shoes of the second circumferential length around a circumference of the hydrostatic low leakage seal.

In a further embodiment of any of the above, a first mass of the first portion of the plurality of shoes is different than a second mass of the second portion of the plurality of shoes.

In a further embodiment of any of the above, a third circumferential length of a third portion of the plurality of shoes is different than the first circumferential length and the second circumferential length.

In another embodiment, a gas turbine engine is disclosed, comprising: a compressor section, a combustor section and a turbine section in serial flow communication, at least one of the compressor section and turbine section including a stator, a rotor, and a seal assembly, the seal assembly comprising: a hydrostatic advanced low leakage seal including: a base; a plurality of shoes of substantially equal circumferential length, wherein a first mass of a first portion of the plurality of shoes is different than a second mass of a second portion of the plurality of shoes; and a plurality of spring elements, each of the plurality of spring elements operatively coupling one of the plurality of shoes to the base; wherein the base is operatively coupled to one of the stator and the rotor.

In a further embodiment of the above, the base is operatively coupled to the stator.

In a further embodiment of any of the above, the plurality of shoes comprise shoes of the first mass alternating with shoes of the second mass around a circumference of the hydrostatic low leakage seal.

In a further embodiment of any of the above, each of the plurality of spring elements comprise substantially the same spring rate.

In a further embodiment of any of the above, a third mass of a third portion of the plurality of shoes is different than the first mass and the second mass.

In another embodiment, a gas turbine engine is disclosed, comprising: a compressor section, a combustor section and a turbine section in serial flow communication, at least one of the compressor section and turbine section including a stator, a rotor, and a seal assembly, the seal assembly comprising: a hydrostatic advanced low leakage seal including: a base; a plurality of shoes, wherein a first circumferential length of a first portion of the plurality of shoes is different than a second circumferential length of a second portion of the plurality of shoes; and a plurality of spring elements, each of the plurality of spring elements operatively coupling one of the plurality of shoes to the base; wherein a first spring rate of a first portion of the plurality of spring elements is different than a second spring rate of a second portion of the plurality of spring elements; wherein the base is operatively coupled to one of the stator and the rotor.

In a further embodiment of the above, the base is operatively coupled to the stator.

In a further embodiment of any of the above, the plurality of shoes comprise shoes of the first circumferential length alternating with shoes of the second circumferential length around a circumference of the hydrostatic low leakage seal.

In a further embodiment of any of the above, a first mass of the first portion of the plurality of shoes is different than a second mass of the second portion of the plurality of shoes.

In a further embodiment of any of the above, a third circumferential length of a third portion of the plurality of shoes is different than the first circumferential length and the second circumferential length.

Other embodiments are also disclosed.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic partial cross-sectional view of a gas turbine engine in an embodiment.

FIG. 2 is a schematic elevational view of a hybrid seal in an embodiment.

FIG. 3 is a schematic perspective view of a hybrid seal and carrier in an embodiment.

FIG. 4 is a schematic cross-sectional view of a rotor, a stator, and a hybrid seal in an embodiment.

FIG. 5 is a schematic cross-sectional view of a rotor, a stator, and a hybrid seal in an embodiment.

FIG. 6 is a schematic cross-sectional view of a rotor, a stator, and a hybrid seal in an embodiment.

### DETAILED DESCRIPTION OF THE DISCLOSED EMBODIMENTS

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

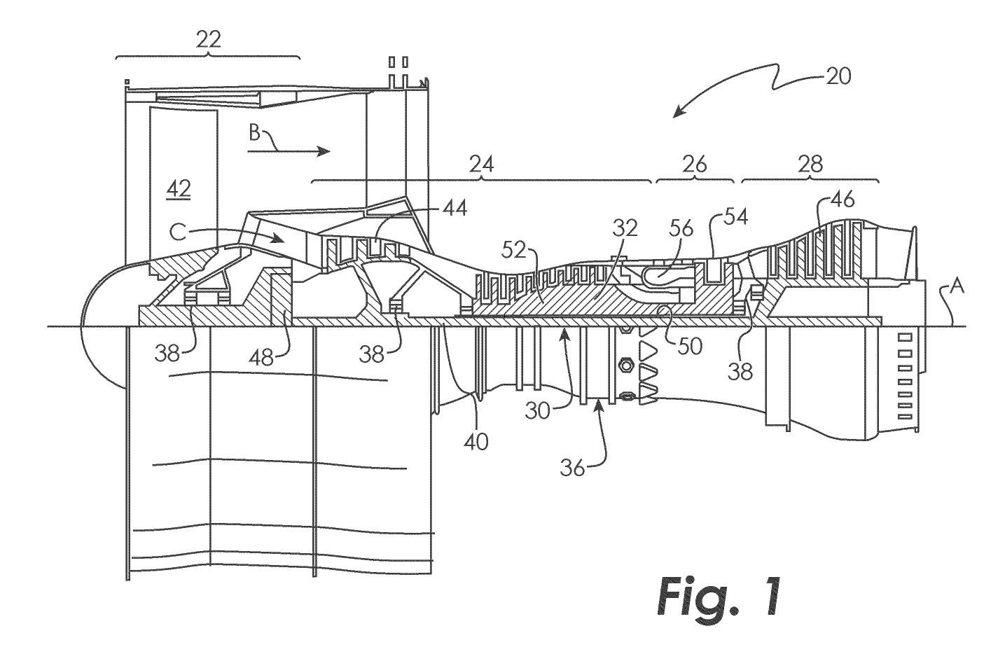

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram° R)/(518.7° R)]^{0.5}. The “Low corrected fan tip speed” as disclosed herein according to one non-limiting embodiment is less than about 1150 ft/second.

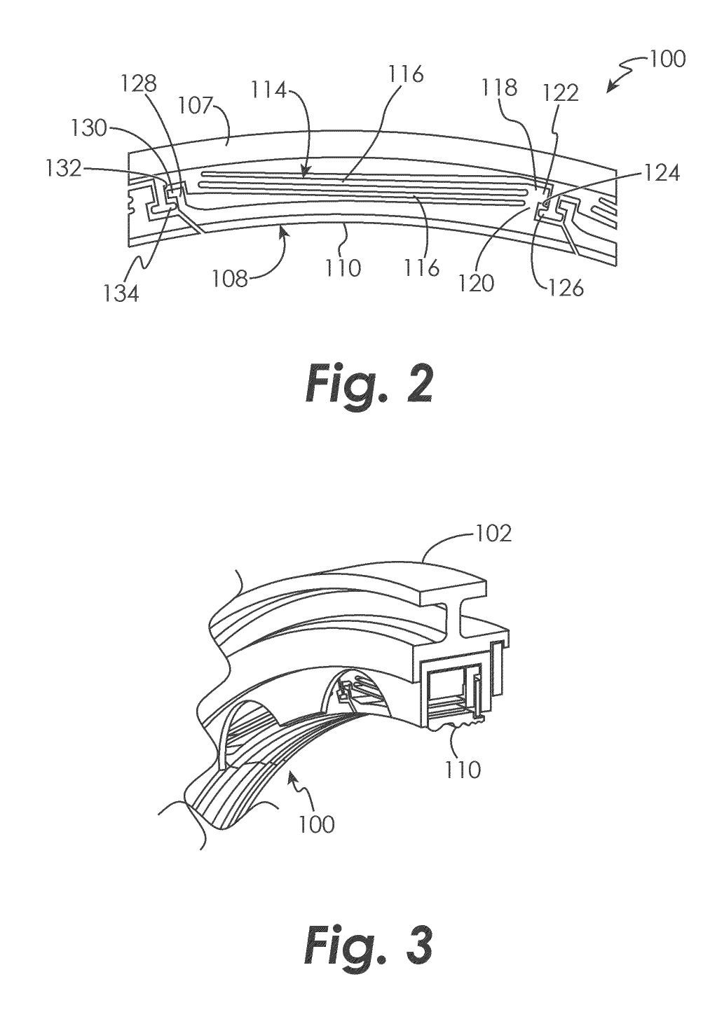

FIGS. 2-6 schematically illustrate a hydrostatic advanced low leakage seal, or hybrid seal, indicated generally at 100, and its associated carrier components. Although the hybrid seal 100 is shown mounted on a stator 102, it will be appreciated that the hybrid seal 100 could alternatively be mounted to a rotor 104. The hybrid seal 100 is intended to create a seal of the circumferential gap 106 between two relatively rotating components, such as the fixed stator 102 and a rotating rotor 104. The hybrid seal 100 includes a base portion 107 and at least one, but often a plurality of circumferentially spaced shoes 108 which are located in a non-contact position along the exterior surface of the rotor 104. Each shoe 108 is formed with a sealing surface 110. For purposes of the present disclosure, the term “axial” or “axially spaced” refers to a direction along the longitudinal axis of the stator 102 and rotor 104, whereas “radial” refers to a direction perpendicular to the longitudinal axis.

Under some operating conditions, it is desirable to limit the extent of radial movement of the shoes 108 with respect to the rotor 104 to maintain tolerances, e.g. the spacing between the shoes 108 and the facing surface of the rotor 104. The hybrid seal 100 includes at least one circumferentially spaced spring element 114, the details of one of which are best seen in FIG. 2. Each spring element 114 is formed with at least one beam 116. One end of each of the beams 116 is mounted to or integrally formed with the base 107 and the opposite end thereof is connected to a first stop 118. The first stop 118 includes a strip 120 which is connected to the shoe 108, and has an arm 122 which may be received within a recess 124 formed in the base 107. The recess 124 has a shoulder 126 positioned in alignment with the arm 122 of the first stop 118.

A second stop 128 is connected to or integrally formed with the strip 120, and, hence connects to the shoe 108. The second stop 128 is circumferentially spaced from the first stop 118 in a position near the point at which the beams 116 connect to the base 107. The second stop 128 is formed with an arm 130 which may be received within a recess 132 in the base 107. The recess 132 has a shoulder 134 positioned in alignment with the arm 130 of second stop 128.

Particularly when the hybrid seal 100 is used in applications such as gas turbine engines, aerodynamic forces are developed which apply a fluid pressure to the shoe 108 causing it to move radially with respect to the rotor 104. The fluid velocity increases as the gap 106 between the shoe 108 and rotor 104 increases, thus reducing pressure in the gap 106 and drawing the shoe 108 radially inwardly toward the rotor 104. As the gap 106 closes, the velocity decreases and the pressure increases within the gap 106, thus forcing the shoe 108 radially outwardly from the rotor 104. The spring elements 114 deflect and move with the shoe 108 to create a primary seal of the circumferential gap 106 between the rotor 104 and stator 102 within predetermined design tolerances. The purpose of first and second stops 118 and 128 is to limit the extent of radially inward and outward movement of the shoe 108 with respect to the rotor 104 for safety and operational limitation. A gap is provided between the arm 122 of first stop 118 and the shoulder 126, and between the arm 130 of second stop 128 and shoulder 134, such that the shoe 108 can move radially inwardly relative to the rotor 104. Such inward motion is limited by engagement of the arms 122, 130 with shoulders 126 and 134, respectively, to prevent the shoe 108 from contacting the rotor 104 or exceeding design tolerances for the gap 106 between the two. The arms 122 and 130 also contact the base 107 in the event the shoe 108 moves radially outwardly relative to the rotor 104, to limit movement of the shoe 108 in that direction.

Energy from adjacent mechanical or aerodynamic excitation sources (e.g. rotor imbalance, flow through the seal, other sections of the engine, etc.) may be transmitted seal 100, potentially creating a vibratory response in the seal 100. Such vibratory responses create vibratory stress leading to possible reduced life of the seal 100, and can be large enough to cause unintended deflections of the shoes 108.

The presently disclosed embodiments employ vibration mistuning of the seal 100 assembly in order to minimize or eliminate the creation of a vibratory response in the seal 100 and the transmission of vibratory energy around the seal 100. By introducing vibration mistuning into the seal 100, energy from adjacent excitation sources is not transmitted as efficiently through the seal 100 structure. The resulting vibratory response and thus vibratory stress and deflections will therefore be reduced.

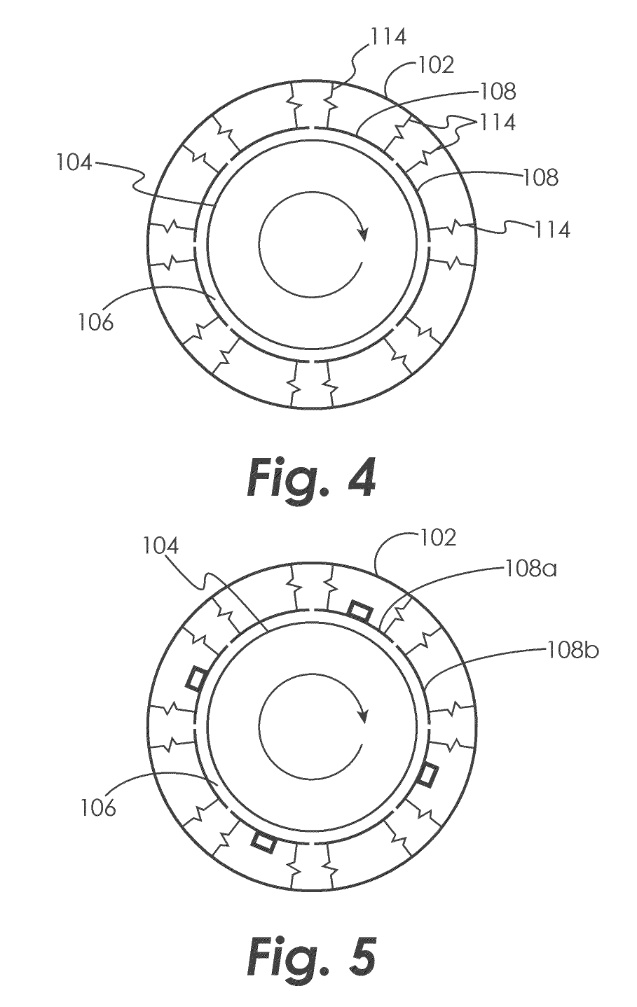

As shown schematically in FIG. 4, the seal 100 shoes 108 may be formed in substantially equal circumferential lengths. Each shoe 108 is supported by spring elements 114 having the same spring rate. The mechanical portions of the seal 100 will couple with mechanical excitation or aerodynamic flow through the system. Because each shoe 108/spring element 114 is substantially identical, each shoe 108/spring element 114 combination will have substantially identical natural frequencies. The vibratory response of the shoes 108 at these natural frequencies, while interacting with mechanical excitation or aerodynamic flow through the system, can reinforce each other causing unwanted vibration levels and possible deflection of the shoes 108 as the vibration is transmitted to all of the shoes 108.

FIG. 5 schematically illustrates a seal 100 having shoes 108 formed in substantially equal circumferential lengths. Each shoe 108 is supported by spring elements 114 having the same spring rate. In order to mistune the seal 100 so that each shoe 108 does not exhibit the same vibratory response, the mass of some shoes 108a are caused to be different than the mass of other shoes 108b. As shown schematically in FIG. 5, additional mass has been added to the shoes 108a as compared to the mass of shoes 108b. In an embodiment, the positions of shoes 108a alternate with the positions of shoes 108b. More than two different shoe masses may be used for the shoes 108 of the seal 100 in some embodiments. Because the resonant frequency response is a function of the square root of the ratio of spring element 114 stiffness to the mass, increasing the mass of the shoes 108a will cause the resonant frequency of the shoes 108a to be lower than the resonant frequency of the shoes 108b. By introducing vibration mistuning into the seal 100 assembly, energy from adjacent excitation sources is not transmitted as efficiently through the seal 100 structure. The resulting vibratory response and thus the vibratory stress and deflections will therefore be reduced.

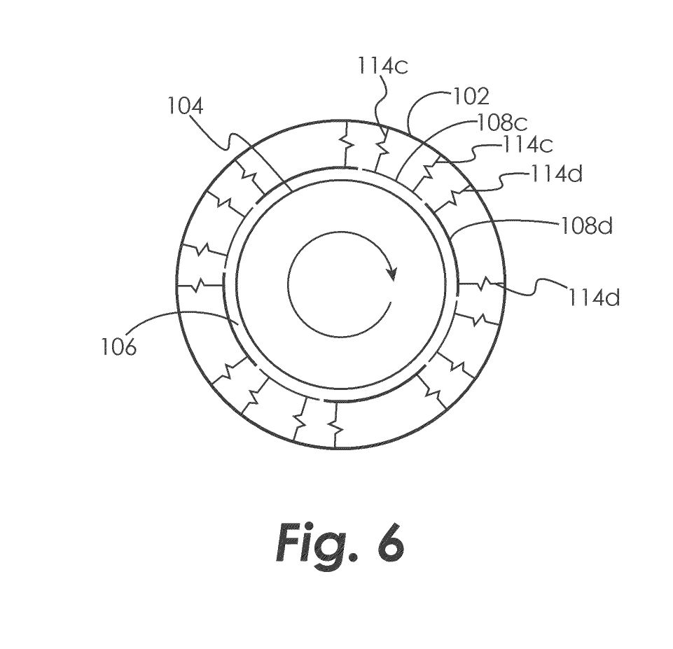

FIG. 6 schematically illustrates a seal 100 having shoes 108 formed in unequal circumferential lengths. For example, each shoe 108c covers a smaller circumferential arc than each shoe 108d. Because the pressure differential is applied to a smaller surface area on the shoe 108c compared to the shoe 108d, each shoe 108c is supported by spring elements 114c having a different spring rate than the spring elements 114d supporting shoes 108d in order to keep the static deflection the same. Because the masses of the shoes 108c and 108d are different, and the spring elements 114c have different spring rates that the spring elements 114d, the vibratory frequencies of adjacent shoes are not equal and the seal 100 is mistuned. The vibratory frequency of either shoe 108c and/or 108d may be further adjusted by changing the mass of the shoe and/or the spring stiffness. In an embodiment, the positions of shoes 108c alternate with the positions of shoes 108d. More than two different arc lengths may be used for the shoes 108 of the seal 100 in some embodiments. By introducing vibration mistuning into the seal 100 assembly, energy from adjacent excitation sources is not transmitted as efficiently through the seal 100 structure. The resulting vibratory response and thus the vibratory stress and deflections will therefore be reduced.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed:

1. A seal assembly disposed between a stator and a rotor, the seal assembly comprising:
a hydrostatic advanced low leakage seal including:
a base;
a plurality of shoes of substantially equal circumferential length, wherein a first mass of a first portion of the plurality of shoes is different than a second mass of a second portion of the plurality of shoes; and
a plurality of spring elements, each of the plurality of spring elements operatively coupling one of the plurality of shoes to the base;
wherein the base is operatively coupled to one of the stator and the rotor.

2. The seal assembly of claim 1, wherein the base is operatively coupled to the stator.

3. The seal assembly of claim 1, wherein the plurality of shoes comprise shoes of the first mass alternating with shoes of the second mass around a circumference of the hydrostatic low leakage seal.

4. The seal assembly of claim 1, wherein each of the plurality of spring elements comprise substantially the same spring rate.

5. The seal assembly of claim 1, wherein a third mass of a third portion of the plurality of shoes is different than the first mass and the second mass.

6. A seal assembly disposed between a stator and a rotor, the seal assembly comprising:
a hydrostatic advanced low leakage seal including:
a base;
a plurality of shoes, wherein a first circumferential length of a first portion of the plurality of shoes is different than a second circumferential length of a second portion of the plurality of shoes; and
a plurality of spring elements, each of the plurality of spring elements operatively coupling one of the plurality of shoes to the base;
wherein a first spring rate of a first portion of the plurality of spring elements is different than a second spring rate of a second portion of the plurality of spring elements;
wherein the base is operatively coupled to one of the stator and the rotor.

7. The seal assembly of claim 6, wherein the base is operatively coupled to the stator.

8. The seal assembly of claim 6, wherein the plurality of shoes comprise shoes of the first circumferential length alternating with shoes of the second circumferential length around a circumference of the hydrostatic low leakage seal.

9. The seal assembly of claim 6, wherein a first mass of the first portion of the plurality of shoes is different than a second mass of the second portion of the plurality of shoes.

10. The seal assembly of claim 6, wherein a third circumferential length of a third portion of the plurality of shoes is different than the first circumferential length and the second circumferential length.

11. A gas turbine engine comprising:
a compressor section, a combustor section and a turbine section in serial flow communication, at least one of the compressor section and turbine section including a stator, a rotor, and a seal assembly, the seal assembly comprising:
a hydrostatic advanced low leakage seal including:
a base;
a plurality of shoes of substantially equal circumferential length, wherein a first mass of a first portion of the plurality of shoes is different than a second mass of a second portion of the plurality of shoes; and
a plurality of spring elements, each of the plurality of spring elements operatively coupling one of the plurality of shoes to the base;
wherein the base is operatively coupled to one of the stator and the rotor.

12. The gas turbine engine of claim 11, wherein the base is operatively coupled to the stator.

13. The seal assembly of claim 11, wherein the plurality of shoes comprise shoes of the first mass alternating with shoes of the second mass around a circumference of the hydrostatic low leakage seal.

14. The seal assembly of claim 11, wherein each of the plurality of spring elements comprise substantially the same spring rate.

15. The seal assembly of claim 11, wherein a third mass of a third portion of the plurality of shoes is different than the first mass and the second mass.

16. A gas turbine engine comprising:
a compressor section, a combustor section and a turbine section in serial flow communication, at least one of the compressor section and turbine section including a stator, a rotor, and a seal assembly, the seal assembly comprising:
a hydrostatic advanced low leakage seal including:
a base;
a plurality of shoes, wherein a first circumferential length of a first portion of the plurality of shoes is different than a second circumferential length of a second portion of the plurality of shoes; and
a plurality of spring elements, each of the plurality of spring elements operatively coupling one of the plurality of shoes to the base;
wherein a first spring rate of a first portion of the plurality of spring elements is different than a second spring rate of a second portion of the plurality of spring elements;
wherein the base is operatively coupled to one of the stator and the rotor.

17. The gas turbine engine of claim 16, wherein the base is operatively coupled to the stator.

18. The seal assembly of claim 16, wherein the plurality of shoes comprise shoes of the first circumferential length alternating with shoes of the second circumferential length around a circumference of the hydrostatic low leakage seal.

19. The seal assembly of claim 16, wherein a first mass of the first portion of the plurality of shoes is different than a second mass of the second portion of the plurality of shoes.

20. The seal assembly of claim 16, wherein a third circumferential length of a third portion of the plurality of shoes is different than the first circumferential length and the second circumferential length.
